(19) United States
(12) Patent Application Publication
(10) Pub. No.: US 2025/0348437 A1
(43) Pub. Date: Nov. 13, 2025

(54) DATAPATH ARCHITECTURES WITH A GENERALIZED PARALLELISM PARADIGM

(71) Applicant: Micron Technology, Inc., Boise, ID (US)

(72) Inventor: Mauro Castelli, Avezzano (IT)

(21) Appl. No.: 19/173,957

(22) Filed: Apr. 9, 2025

Related U.S. Application Data
(60) Provisional application No. 63/646,063, filed on May 13, 2024.

(51) Int. Cl. G06F 12/1045; G06F 12/0844

(52) U.S. Cl. CPC G06F 12/1045; G06F 12/0844

(57) ABSTRACT

A method includes identifying a logical address of a logical address space, translating the logical address to a set of physical addresses of a physical address space by using a set of translation functions, the set of translation functions including a position address translation function that translates the logical address to a position address of the set of physical addresses based on a cardinality of a set of datacache sections, and a section address translation function that translates the logical address to a section address of the set of physical addresses based on the cardinality of the set of datacache sections, and causing, using the position address and the section address, the set of datacache sections to process a set of media access operations in parallel, each media access operation of the set of media access operations corresponding to a respective datacache section of the set of datacache sections.

### CROSS-REFERENCE TO RELATED APPLICATION(S)

The present application claims priority to U.S. Provisional Patent Application No. 63/646,063, filed on May 13, 2024 and entitled “DATAPATH ARCHITECTURES WITH A GENERALIZED PARALLELISM PARADIGM”, the entire contents of which are hereby incorporated by reference herein.

### TECHNICAL FIELD

Embodiments of the disclosure relate generally to memory sub-systems, and more specifically, relate to datapath architectures with a generalized parallelism paradigm.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIGS. 1A-2C are diagrams of an example computing systems that includes a memory sub-system, in accordance with some embodiments of the present disclosure.

FIGS. 3A-3B are diagrams illustrating an example datapath architecture with a generalized parallelism paradigm, in accordance with some embodiments of the present disclosure.

FIG. 4 is a diagram illustrating an example mapping between a physical address space and a logical address space, in accordance with some embodiments of the present disclosure.

FIG. 5 is a flow diagram of an example method to implement a datapath architecture with a generalized parallelism paradigm, in accordance with some embodiments of the present disclosure.

FIG. 6 is a block diagram of an example computer system in which embodiments of the present disclosure may operate.

### DETAILED DESCRIPTION

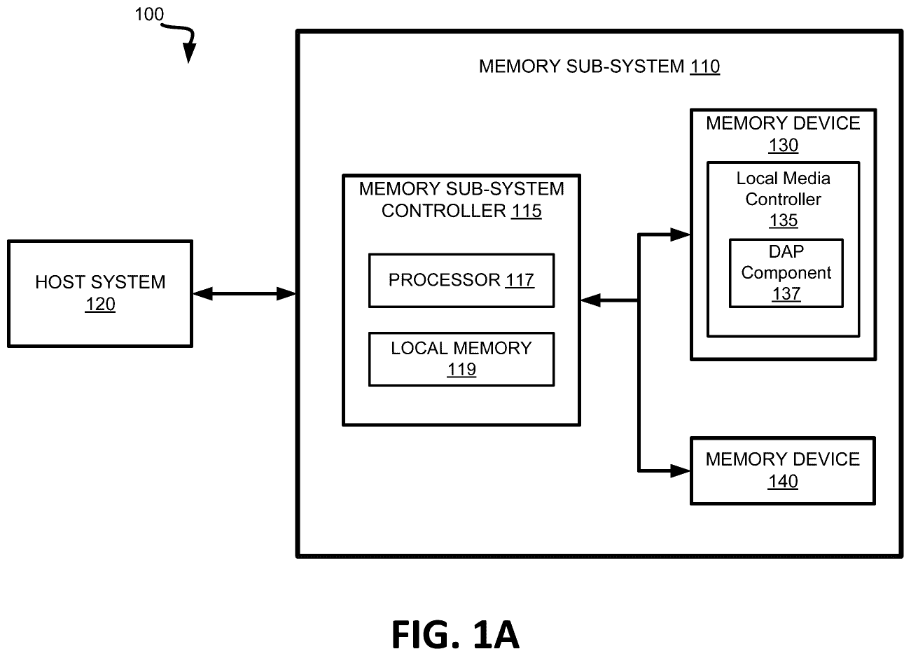

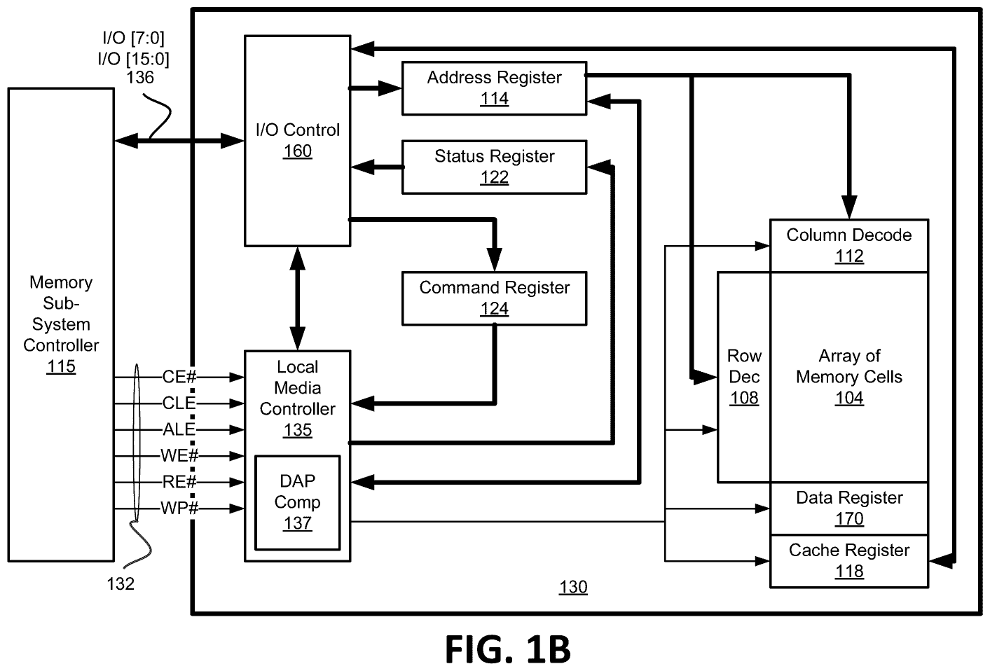

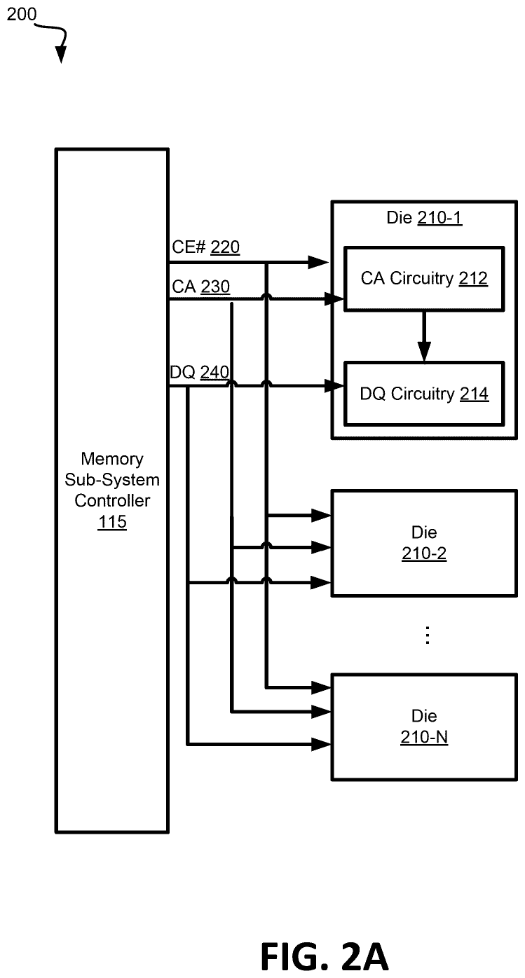

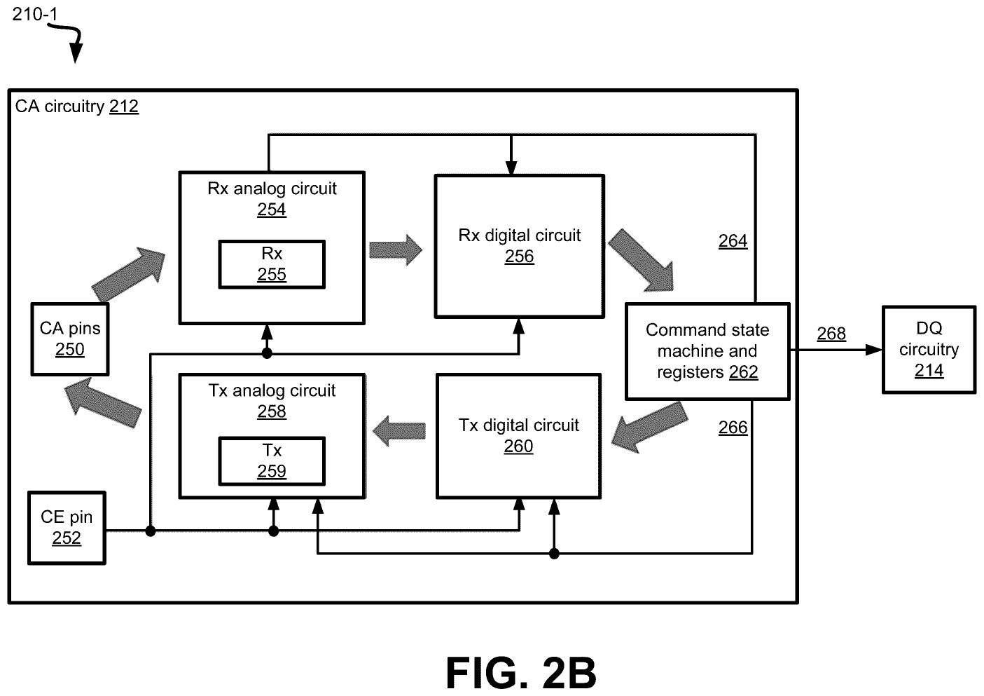

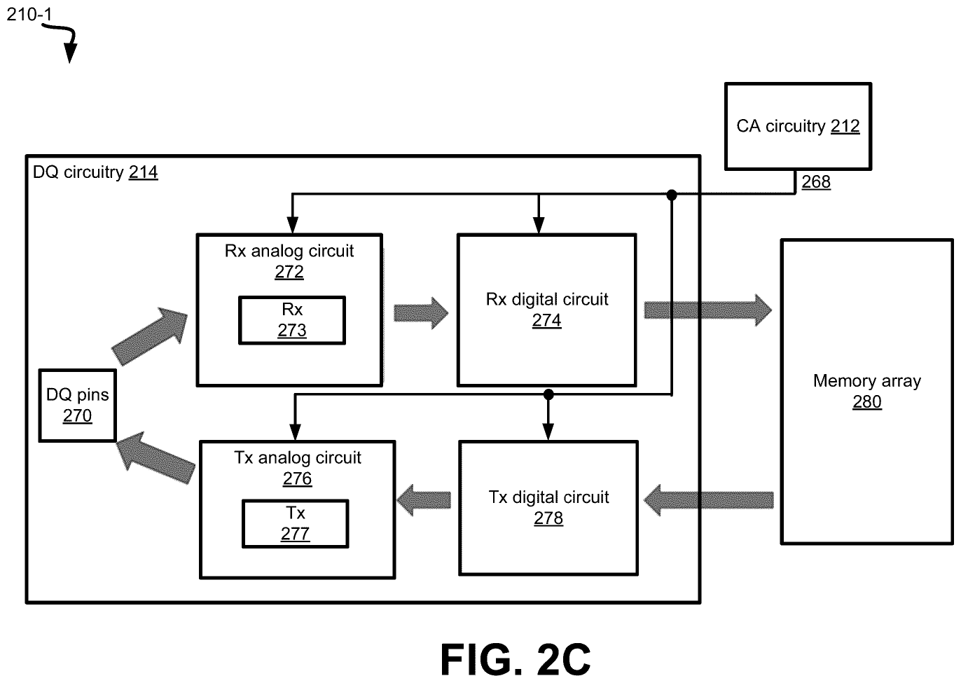

Aspects of the present disclosure are directed to datapath architectures with a generalized parallelism paradigm. A memory sub-system can be a storage device, a memory module, or a combination of a storage device and memory module. Examples of storage devices and memory modules are described below in conjunction with FIGS. 1A-2C. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a negative-and (NAND) memory device. Other examples of non-volatile memory devices are described below in conjunction with FIGS. 1A-2C. A non-volatile memory device is a package of one or more dies. Each die can include one or more planes. For some types of non-volatile memory devices (e.g., NAND devices), each plane includes a set of physical blocks. Each block includes a set of pages. Each page includes a set of memory cells. A memory cell is an electronic circuit that stores information. Depending on the memory cell type, a memory cell can store one or more bits of binary information, and has various logic states that correlate to the number of bits being stored. The logic states can be represented by binary values, such as “0” and “1”, or combinations of such values.

A memory sub-system can include an interface, between a memory sub-system controller and one or more memory devices, that can process multiple different signals relating to communications with the memory devices. The interface can utilize a set of command pins to implement interface protocols

Media access operation (e.g., read and/or write) performance can be improved by increasing data transfer speed across an input/output (I/O) interface of a memory device (e.g., NAND flash device). To increase data transfer speed, media access operations can be performed in parallel. For example, a datacache (which can include page buffers and/or registers) can be divided into multiple sections that can be accessed (e.g., read and/or written to) approximately simultaneously in parallel. The size of a section of the datacache can depend on the size of a page of the memory device. Illustratively, if a page is a 16 kilobyte (KB) page, then each section of the datacache can have a size of 16/N KB, where N is the number of sections. Each section of the datacache can be assigned to a data (DQ) bus to handle a respective media access operation. Operation timing is defined as the product of the number of sections of the datacache (N) and an I/O interface data transfer speed (e.g., I/O interface data period). Operation timing can have a direct relationship to the number of sections of the datacache.

A physical address space refers to a range of locations within a memory device directly accessible by the memory device. A set of physical addresses of the physical address space can define a location of a data item. For example, the set of physical address can include a section address and a position address. The section address specifies a section within which the data item is located, and the position address specifies the location of the data item within the section.

A logical address space refers to a range of addresses used by components external to the memory device (e.g., CPUs, I/O controllers, peripheral devices) to communicate with the memory device. For example, when an external component requests to access a location of a memory device, the external component can provide a logical address. A controller can then translate the logical address to a physical address.

A media access operation (e.g., read, program or erase) can be performed in response to a command. A command can specify the type of operation, and a command address. The command address can include a block address identifying a block where the operation will be performed, and a page address identifying a page within the block where the operation will be performed.

A page can be divided into locations called columns. For some media access operations, the command address can further include a column address that specifies a location within the page where the media access operation will begin. For example, a column address can be used to specify a location within a page to begin writing or programming the page (e.g., partial page programming. As another example, a column address can be used to specify a location of a data item of a page to beginning reading the page.

For 8-bit interfaces, a data item of a page is a byte, and each column address references a respective byte of the page. For example, for a 2 kilobyte (KB) page including 2048 bytes with an 8-bit interface, there are 2048 possible column addresses for the page, where each column address references a respective byte of the page. Eleven bits would be needed to represent all possible column addresses within the 2 KB page using the 8-bit interface (211=2048 bytes). As another example, for a 16 KB page including 16,384 bytes with an 8-bit interface, there are 16,384 possible column addresses for the page, where each column address references a respective byte of the page. Fourteen bits would be needed to represent all possible column addresses within the 16 KB page using the 8-bit interface (214=16,384 bytes).

For 16-bit interfaces, a data item of a page is a word defined by 2 bytes of data, and each column address references a respective word of the page. For example, for a 2 KB page with a 16-bit interface, there are 1024 possible column addresses for the page, where each column address references a respective word of the page. Ten bits would be needed to represent all possible column addresses within the 2 KB page using the 16-bit interface (210=1024 words). As another example, for a 16 KB page with a 16-bit interface, there are 8,192 possible column addresses for the page, where each column address references a respective word of the page. Thirteen bits would be needed to represent all possible column addresses within the 16 KB page using the 16-bit interface (213=8,192 bytes).

More specifically, a column address identifies a starting data item (e.g., byte or word) within a page where the media access operation will begin. For example, for an 8-bit interface, a column address of 512 can indicate that the starting location of a media access operation performed with respect to a page is the 512^{th} bit of the page. As another example, for a 16-bit interface, a column address of 512 can indicate that the starting location of a media access operation performed with respect to a page is the 512^{th} word of the page.

For example, a column address can be a k-bit column address represented by CA[k−1:0], where CA stands for column address and [k−1:0] indicates the bit range. This means that an address bus used for holding the column address has k lines, labeled from k−1 down to 0. More specifically, “k−1” refers to the most significant bit of the bit range and “0” represents the least significant bit of the bit range. A k-bit column address can support 24 possible unique column addresses. The type of memory interface (8-bit, 16-bit, etc.) can be used to determine how much data a single column address points to. In some implementations, the column address is a 15-bit column address (k=15) represented by CA[14:0]. In these implementations, 32,768 possible unique column addresses are supported.

The section address for a data item of a page (e.g., byte or word) can be represented by CA[m−1:0]. The position address for the data item of the page can be represented by CA[k−1:m]. In these implementations, the number m is determined as the logarithm base two of N (m=x).

Typically, the number of sections of the datacache (N) is a fixed number that is a power of two (e.g., N=2^{x}, where x is a positive integer). That is, the number of sections of the datacache can be increased by doubling the previous number of sections of the datacache. Implementing such a power-of-two parallelism paradigm can lead to an inefficient use of resources due to exponential growth resulting from the doubling, which can make it difficult or impossible to implement the corresponding datapath architecture to process the number of datacache sections.

Illustratively, assume that a datapath architecture is designed to process 32 datacache sections in parallel (N=32). In a power-of-two parallelism paradigm, the only way to increase the number of datacache sections that can be processed in parallel is by designing the datapath architecture to process 64 datacache sections in parallel. However, due to cost and/or on-chip footprint constraints, it may not be practical or possible to implement such a datapath architecture.

Additionally, an engineer may want to design a datapath architecture to achieve a minimum operation processing speed that could be realized by processing a non-power-of-two number of datacache sections in parallel. For example, assume that an engineer wants to design a datapath architecture to achieve a target operation processing speed that can be realized by processing a non-power of two number of datacache sections between 32 and 64 in parallel (e.g., 40 datacache sections). Under the constraints of the power-of-two parallelism paradigm, the smallest datapath architecture that can be used to achieve the target operation processing speed is one that is designed to process 64 datacache sections in parallel (since the operation processing speed achievable by a datapath architecture designed to process 32 datacache sections in parallel would be less than the target). However, a datapath architecture designed to process 64 datacache sections in parallel would take up a larger-than-necessary amount of on-chip surface area, as compared to a theoretical datapath architecture designed to process fewer than 64 datacache sections in parallel (e.g., 40 datacache sections) that can achieve the target operation processing speed. Accordingly, the power-of-two parallelism paradigm can contribute to memory device performance bottlenecks and/or datapath architecture design inefficiency.

Aspects of the present disclosure address the above and other deficiencies by implementing datapath architectures with a generalized parallelism paradigm. Implementations described herein can be used to design a datapath architecture that can generalize parallelism to any positive integer N (e.g., not limited to a power of two). That is, the datacache may be divided into a number of datacache sections N, where N is not limited to being a power of two. The number N can be chosen to balance operation processing speed in view of the size of the memory device architecture. Illustratively, it may be determined that a datapath architecture can be designed to process a non-power-of-two number of datacache sections in parallel to achieve a target operation processing speed. Assume that the non-power-of-two number of datacache sections is 40 (N=40). Instead having to use a datapath architecture designed to process 64 datacache sections in parallel under the power-of-two parallelism paradigm as described above, the generalized parallelism paradigm described herein can be used to design a more efficient datapath architecture that can process 40 datacache sections in parallel to achieve the target operation processing speed.

As mentioned above, the section address for a data item of a page (e.g., byte or word) can be represented by CA[m−1:0], and the position address for the data item of the page can be represented by CA[k−1:m]. To implement a datapath architecture with a generalized parallelism paradigm, instead of defining m as the logarithm base two of N, m can be defined as the smallest integer number greater than or equal to the logarithm base two of N. This can be represented by m=┌log 2 N┐, where ┌⋅┐ is the ceiling function. Although a data item (e.g., byte or word) can be addressed by determining m in this manner, doing so when N is not a power of two can introduce discontinuities (“holes”) in the column address mapping of a physical address space. The discontinuities reflect non-existing data items (e.g., bytes or words).

To address such discontinuities, a local media controller of the memory device can use a set of translation functions to translate, for a data item (e.g., byte or word), a logical address of a logical address space to a set of physical addresses of a physical address space. For example, the set of translation functions can include a position address translation function that translates the logical address to a position address of the set of physical addresses. As another example, the set of translation functions can further include a section address translation function that translates the logical address to a section address of the physical address space. Accordingly, the set of translation functions is what enables the extension of the power-of-two parallelism paradigm to a generalized parallelism paradigm. Further details regarding implementing datapath architectures with a generalized parallelism paradigm will be described below with reference to FIGS. 1A-6.

Advantages of the present disclosure include, but are not limited to, improved memory device performance and resource efficiency. For example, implementations described herein can increase datapath speeds and input/output (I/O) data rate with a smaller device footprint.

FIG. 1A illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1A illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Pillar, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory device 130) when the memory sub-system 110 is coupled with the host system 120 by the physical host interface (e.g., PCIe bus or CXL bus). The physical host interface can provide an interface for passing control, address, data, and other signals between the memory sub-system 110 and the host system 120. FIG. 1A illustrates a memory sub-system 110 as an example. In general, the host system 120 can access multiple memory sub-systems via a same communication connection, multiple separate communication connections, and/or a combination of communication connections.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a negative-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

The memory device 130 can include one or more arrays of memory cells. One type of memory cell, for example, single level memory cells (SLC) can store one bit per memory cell. Other types of memory cells, such as multi-level memory cells (MLCs), triple level memory cells (TLCs), quad-level memory cells (QLCs), and penta-level memory cells (PLCs) can store multiple bits per memory cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory device 130 can be grouped as pages that can refer to a logical unit of the memory device used to store data. With some types of memory (e.g., NAND), pages can be grouped to form blocks.

Although non-volatile memory components such as NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1A has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory device 130. The memory sub-system controller 115 can further include host interface circuitry to communicate with the host system 120 via the physical host interface. The host interface circuitry can convert the commands received from the host system into command instructions to access the memory device 130 as well as convert responses associated with the memory device 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory device 130.

In some embodiments, the memory device 130 includes local media controller 135 that operates in conjunction with memory sub-system controller 115 to execute operations on one or more memory cells of the memory device 130. An external controller (e.g., memory sub-system controller 115) can externally manage the memory device 130 (e.g., perform media management operations on the memory device 130). In some embodiments, memory sub-system 110 includes a managed memory device, which includes a raw memory device 130 having control logic (e.g., local controller 132) on the die and a controller (e.g., memory sub-system controller 115) for media management within the same memory device package. An example of a managed memory device is a managed NAND (MNAND) device.

The memory sub-system 110 includes datapath architecture parallelism (DAP) component 137 that can be used to enable a datapath architecture with a generalized parallelism paradigm. In some embodiments, local media controller 135 includes at least a portion of DAP component 137 and is configured to perform the functionality described herein. In some embodiments, the memory sub-system controller 115 includes at least a portion of DAP component 137. In some embodiments, DAP component 137 is part of the host system 120, an application, or an operating system. Further details regarding DAP component 137 and enabling a datapath architecture with a generalized parallelism paradigm will be described below with reference to FIGS. 1B-5.

FIG. 1B is a simplified block diagram of a first apparatus, in the form of a memory device 130, in communication with a second apparatus, in the form of a memory sub-system controller 115 of a memory sub-system (e.g., memory sub-system 110 of FIG. 1A), according to an embodiment. Some examples of electronic systems include personal computers, personal digital assistants (PDAs), digital cameras, digital media players, digital recorders, games, appliances, vehicles, wireless devices, mobile telephones and the like. The memory sub-system controller 115 (e.g., a controller external to the memory device 130), may be a memory controller or other external host device.

Memory device 130 includes an array of memory cells 104 logically arranged in rows and columns. Memory cells of a logical row are connected to the same access line (e.g., a wordline) while memory cells of a logical column are selectively connected to the same data line (e.g., a bitline). A single access line may be associated with more than one logical row of memory cells and a single data line may be associated with more than one logical column. Memory cells (not shown in FIG. 1B) of at least a portion of array of memory cells 104 are capable of being programmed to one of at least two target data states.

Row decode circuitry 108 and column decode circuitry 112 are provided to decode address signals. Address signals are received and decoded to access the array of memory cells 104. Memory device 130 also includes input/output (I/O) control circuitry 160 to manage input of commands, addresses and data to the memory device 130 as well as output of data and status information from the memory device 130. An address register 114 is in communication with I/O control circuitry 160 and row decode circuitry 108 and column decode circuitry 112 to latch the address signals prior to decoding. A command register 124 is in communication with I/O control circuitry 160 and local media controller 135 to latch incoming commands.

A controller (e.g., the local media controller 135 internal to the memory device 130) controls access to the array of memory cells 104 in response to the commands and generates status information for the external memory sub-system controller 115, i.e., the local media controller 135 is configured to perform access operations (e.g., read operations, programming operations and/or erase operations) on the array of memory cells 104. The local media controller 135 is in communication with row decode circuitry 108 and column decode circuitry 112 to control the row decode circuitry 108 and column decode circuitry 112 in response to the addresses. In one embodiment, local media controller 135 includes the DAP component 137, which can implement the defect detection described herein during an erase operation on memory device 130.

The local media controller 135 is also in communication with a cache register 118. Cache register 118 latches data, either incoming or outgoing, as directed by the local media controller 135 to temporarily store data while the array of memory cells 104 is busy writing or reading, respectively, other data. During a program operation (e.g., write operation), data may be passed from the cache register 118 to the data register 170 for transfer to the array of memory cells 104; then new data may be latched in the cache register 118 from the I/O control circuitry 160. During a read operation, data may be passed from the cache register 118 to the I/O control circuitry 160 for output to the memory sub-system controller 115; then new data may be passed from the data register 170 to the cache register 118. The cache register 118 and/or the data register 170 may form (e.g., may form a portion of) a page buffer of the memory device 130. A page buffer may further include sensing devices (not shown in FIG. 1B) to sense a data state of a memory cell of the array of memory cells 204, e.g., by sensing a state of a data line connected to that memory cell. A status register 122 may be in communication with I/O control circuitry 160 and the local memory controller 135 to latch the status information for output to the memory sub-system controller 115.

Memory device 130 receives control signals at the memory sub-system controller 115 from the local media controller 135 over a control link 132. For example, the control signals can include a chip enable signal CE #, a command latch enable signal CLE, an address latch enable signal ALE, a write enable signal WE #, a read enable signal RE #, and a write protect signal WP #. Additional or alternative control signals (not shown) may be further received over control link 132 depending upon the nature of the memory device 130. In one embodiment, memory device 130 receives command signals (which represent commands), address signals (which represent addresses), and data signals (which represent data) from the memory sub-system controller 115 over a multiplexed input/output (I/O) bus 136 and outputs data to the memory sub-system controller 115 over I/O bus 136.

For example, the commands may be received over input/output (I/O) pins [7:0] of I/O bus 136 at I/O control circuitry 160 and may then be written into command register 124. The addresses may be received over input/output (I/O) pins [7:0] of I/O bus 136 at I/O control circuitry 160 and may then be written into address register 114. The data may be received over input/output (I/O) pins [7:0] for an 8-bit device or input/output (I/O) pins [15:0] for a 16-bit device at I/O control circuitry 160 and then may be written into cache register 118. The data may be subsequently written into data register 170 for programming the array of memory cells 104.

In an embodiment, cache register 118 may be omitted, and the data may be written directly into data register 170. Data may also be output over input/output (I/O) pins [7:0] for an 8-bit device or input/output (I/O) pins [15:0] for a 16-bit device. Although reference may be made to I/O pins, they may include any conductive node providing for electrical connection to the memory device 130 by an external device (e.g., the memory sub-system controller 115), such as conductive pads or conductive bumps as are commonly used.

It will be appreciated by those skilled in the art that additional circuitry and signals can be provided, and that the memory device 130 of FIGS. 1A-1B has been simplified. It should be recognized that the functionality of the various block components described with reference to FIGS. 1A-1B may not necessarily be segregated to distinct components or component portions of an integrated circuit device. For example, a single component or component portion of an integrated circuit device could be adapted to perform the functionality of more than one block component of FIGS. 1A-1B. Alternatively, one or more components or component portions of an integrated circuit device could be combined to perform the functionality of a single block component of FIGS. 1A-1B. Additionally, while specific I/O pins are described in accordance with popular conventions for receipt and output of the various signals, it is noted that other combinations or numbers of I/O pins (or other I/O node structures) may be used in the various embodiments.

FIG. 2A is a diagram of a system 200, in accordance with some embodiments of the present disclosure. For example, system 200 can correspond to memory sub-system 110 of FIG. 1A. As shown, system 200 includes memory sub-system controller 115 of FIGS. 1A-1B, and multiple dies 210-1 through 210-N. The number of dies, N, should not be considered limiting. In some implementations, each of dies 210-1 through 210-N is included in the same memory device (e.g., memory device 130 of FIGS. 1A-1B). In some implementations, at least one of dies 210-1 through 210-N is included in a first memory device and at least one of dies 210-1 through 210-N is included in a second memory device different from the first memory device.

Die 210-1 includes CA circuitry 212 and DQ circuitry 214. Although only shown with respect to die 210-1, each of the other dies 210-2 through 210-N can include CA circuitry and DQ circuitry similar to CA circuitry 212 and DQ circuitry 214, respectively. Further details regarding CA circuitry 212 and DQ circuitry 214 will be described below with reference to FIGS. 2B-2C.

System 200 can further include at least one CE #pin 220 connected, via one or more electrically conductive lines, with dies 210-1 through 210-N. At least one CE #pin 220 can be used to transmit a CE #signal from memory sub-system controller 115 to dies 210-1 through 210-N. For example, for each of dies 210-1 through 210-N, the CE #signal can be received by the respective CA circuitry. That is, only CA circuitry of a die may be enabled by the CE #signal.

System 200 can further include CA bus 230. CA bus 230 can be used to transmit command transactions from memory sub-system controller 115 to respective CA circuitry of dies 210-1 through 210-N (e.g., CA circuitry 212 of die 210-1). CA bus 230 is an m-bit bus, which can be represented by CA[m−1:0], where “m−1” refers to the most significant bit of a range of m bits and “0” represents the least significant bit of the range of m bits. In some implementations, CA bus 230 is a two-bit bus, which can be represented by CA[1:0].

System 200 can further include DQ bus 240. DQ bus 240 can be used to transmit data transactions from memory sub-system controller 115 to respective DQ circuitry of dies 210-1 through 210-N (e.g., DQ circuitry 214 of die 210-1). DQ bus 240 is an n-bit bus, which can be represented by DQ[n−1:0], where “n−1” refers to the most significant bit of a range of n bits and “O” represents the least significant bit of the range of n bits. In some implementations, DQ bus 240 is an eight-bit bus, which can be represented by DQ[7:0].

FIGS. 2B-2C are diagram of die 210-1, in accordance with some embodiments of the present disclosure. As shown in FIG. 2B, CA circuitry 212 can include components including CA pins 250 to receive commands from a CA bus, CE pin 252 to receive CE signals, receiver (Rx) analog circuit 254, Rx digital circuit 256, transmitter (Tx) analog circuit 258, Tx digital circuit 260, and command state machine and registers 262. For example, Rx analog circuit 254 can be implemented by an Rx 255, as well as one or more amplifiers, one or more voltage generators, and one or more analog-to-digital converters (not shown). Rx digital circuit 256 can be implemented by one or more buffers, one or more latches, and combinatorial logic. Tx analog circuit 258 can be implemented by a Tx 259, as well as one or more digital-to-analog converters, one or more voltage level-shifters, and one or more voltage generators (not shown). Tx digital circuit 260 can be implemented by one or more buffers, one or more latches, and combinatorial logic. Command state machine and registers 262 can generate an Rx control signal 264 to control Rx 255, a Tx control signal 266 to control Tx 259 and/or a DQ circuitry control signal 268 to control DQ circuitry 214 (e.g., control the state of DQ circuitry 214).

As shown in FIG. 2C, DQ circuitry 214 can include components including DQ pins 270 to receive commands via a DQ bus, Rx analog circuit 272, Rx digital circuit 274, Tx analog circuit 276, and Tx digital circuit 278. For example, Rx analog circuit 272 can be implemented by an Rx 273, as well as one or more amplifiers, one or more voltage generators, and one or more analog-to-digital converters (not shown). Rx digital circuit 274 can be implemented by one or more buffers, one or more latches, and combinatorial logic. Tx analog circuit 276 can be implemented by a Tx 277, as well as one or more digital-to-analog converters, one or more voltage level-shifters, and one or more voltage generators (not shown). Tx digital circuit 278 can be implemented by one or more buffers, one or more latches, and combinatorial logic. DQ circuitry control signal 268 can be used to control operation of one or more of circuits 272-278 to control the state of DQ circuitry 214. Rx digital circuit 274 and Tx digital circuit 278 can communicate with memory array 280 to cause data to be written to memory array 280 and/or cause data to be read out of memory array 280.

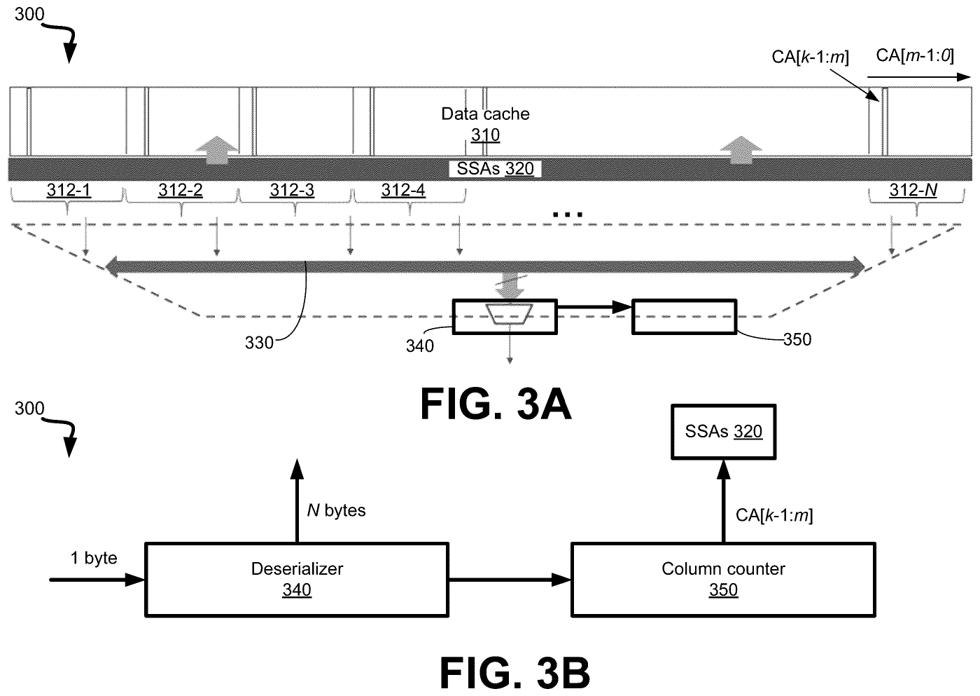

FIGS. 3A-3B are diagrams illustrating an example datapath architecture (“architecture”) 300, in accordance with some embodiments of the present disclosure. Architecture 300 includes datacache 310. In this example, architecture 300 is implementing N-parallelism, where N is a positive integer. Datacache is divided into N sections 312-1 through 312-N. For example, I/O control circuitry (e.g., I/O control circuitry 160 of FIG. 1B can divide the datacache into N sections 312-1 through 312-N. Architecture can further include N secondary sense amplifiers (SSAs) 320, DQ bus 330, deserializer 340, and column counter 350. A primary sense amplifier (PSA) (not shown) can be used to read data from a memory array, while an SSA of SSAs 220 can be utilized to read data from the PSA. In some implementations, an SSA includes a latch. For example, a latch can include a pair of cross-coupled inverters. DQ 330 bus can have a width of 8N.

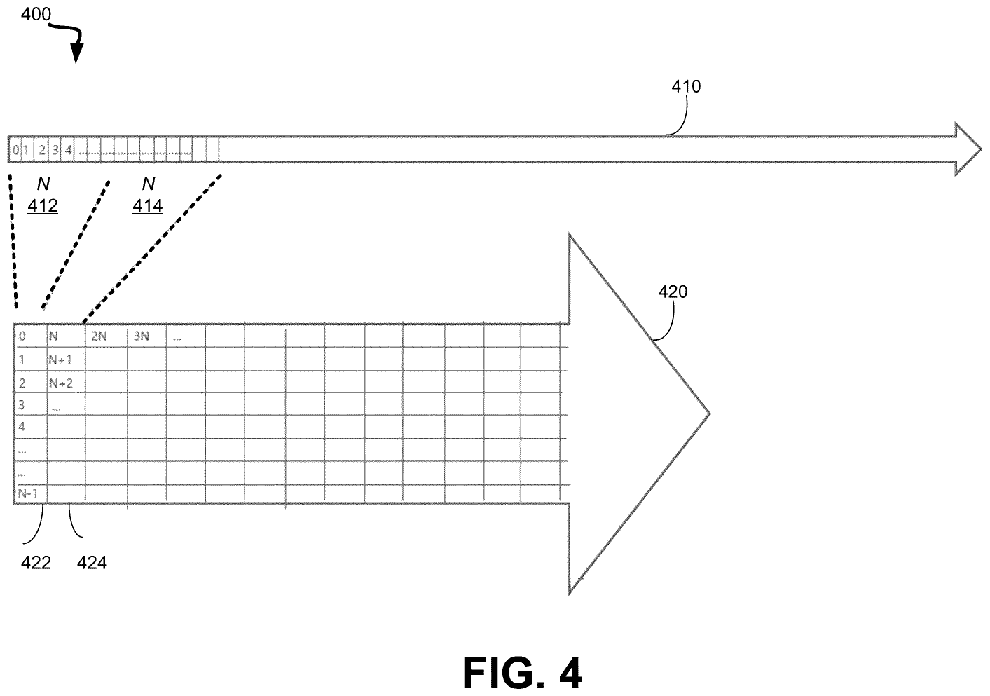

A position address of a data item (e.g., byte or word) within each of the N sections 312-1 through 312-N can be represented by CA[k−1:m], and a section address that the data item is located in can be represented by CA[m−1:0], where m=┌log 2 N┐ as described above. As mentioned above, although a data item (e.g., byte or word) can be addressed by determining m in this manner, doing so when the number of sections of the datacache (N) is not a power of two can introduce discontinuities (“holes”) in the column address mapping of a physical address space. The discontinuities reflect non-existing data items (e.g., bytes or words). Example mappings between a physical address space and a logical address space that introduce discontinuities will now be described below with reference to FIG. 4.

FIG. 4 is a diagram 400A illustrating an example column address mapping of addresses of a physical address space 410 to columns of a logical address space 420, in accordance with some embodiments of the present disclosure. As shown, groups of N address of the physical address space 410 can be mapped to respective columns of the logical address space 420. For example, N addresses 412 including 0 through N−1 can be mapped to column 422, N addresses 414 including N through 2N−1 can be mapped to column 42A, etc. If N is not a power of two number (e.g., 2, 4, 8, 16, 32, . . . ), there may be discontinuities (e.g., holes) introduced in the column address mapping.

Referring back to FIGS. 3A-3B, to address such discontinuities (e.g., those shown in FIG. 4), a local media controller of the memory device (e.g., local media controller 135 of FIGS. 1A-1B) can remove the discontinuities using a set of translation functions (by hiding them from the logical address space). More specifically, the set of translation functions are designed to translate addresses between the physical address space and the logical address space in a manner that removes the discontinuities in the physical address space when mapped to respective addresses of the logical address space. Accordingly, logical address space is a continuous address space.

For example, the set of translation functions can include a section address translation function that defines a section address translation between a logical address of a data item within the logical address space to a corresponding section address of the data item within the physical address space. As another example, the set of translation functions can include a position address translation function that defines a position address translation between a logical address of a data item (e.g., a byte or word) within the logical address space and a position address of the data item within the physical address space. The address translations (e.g., the section address translation and the position address translation) can be sent to I/O control circuitry (e.g., I/O control circuitry 160 of FIG. 1B). After using the set of translation functions, column counter 350 can be initialized based on the translation to count the number of clock pulses or cycles.

For example, a section address identifying a section that a data item (e.g., byte or word) of a page is located in within a physical address space can be represented by CA[m−1:0], and a position address identifying the position of the data item within the section can be represented by CA[k−1:m], where m=┌log 2 N┐ as described above. In some implementations, k=15. A logical address can be represented by Addr_{log}. For example, Addr_{log} can be a value referencing the data item (e.g., byte or word) of the page (e.g., a value of 132 references the 132^{nd} data item of the page).

A section address translation function of the set of translation functions can define the section address as the remainder of a quotient of the logical address divided by the number of sections of the datacache (N). A position address translation function of the set of translation functions can define the position address as the quotient of the logical address divided by N if the logical address is divisible by N (i.e., N is a factor of the logical address), or the non-fractional part of the quotient of the logical address divided by N if the logical address is not divisible by N (i.e., N is not a factor of the logical address). Illustratively, the set of translation functions can include:

$$C A [ m - 1 : 0 ] = {Addr}_{log} mod ( N ) \qquad ( 1 )$$

$$CA [ k - 1 : m ] = trunc ( {Addr}_{log} / N ) \qquad ( 2 )$$

where equation (1) is a section address translation function in which mod (N) is the modulo function that returns the remainder of Addr_{log} divided by N, equation (2) is a position address translation function in which trunc( ) is the truncation function that removes the fractional part of Addr_{log}/N (e.g., rounds the input value down to the nearest lowest integer), and “=” is the assignment operator that translates the logical address to the respective section and position addresses of the physical address space in equations (1) and (2). As an illustrative example, assume that N=40, m=6, k=15 and Addr_{log}=132. Using equation (1), CA[5:0]=132 mod 40=12. Using equation (2), CA[14:5]=trunc(132/40)=trunc(3.3)=3. That is, the section address identifies the section as section 12, and the position addresses identifies the position within section 13 as position 3.

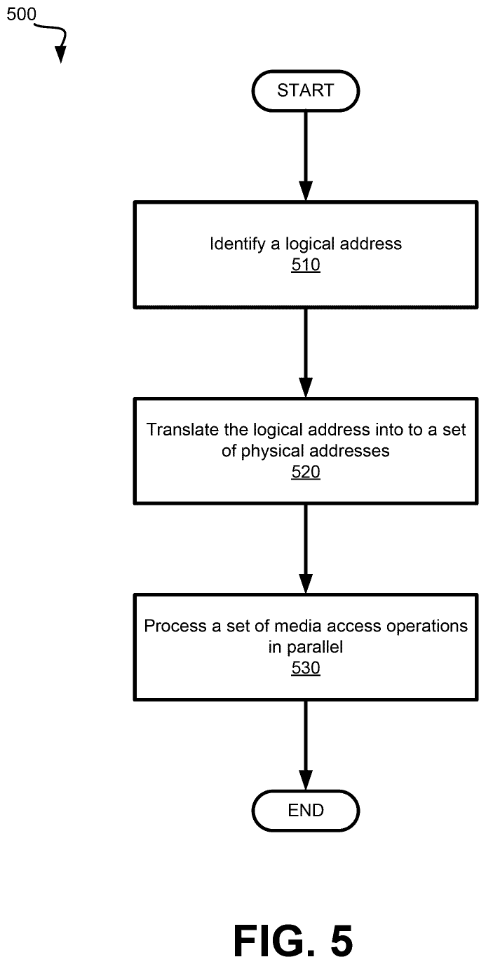

FIG. 5 is a flow diagram of an example method 500 to implement datapath architectures with a generalized parallelism paradigm, in accordance with some embodiments of the present disclosure. Method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, method 500 is performed by local media controller 135 of FIGS. 1A-1B.

At operation 510, a logical address is identified. For example, processing logic can identify a logical address of a logical address space.

At operation 520, the logical address is translated into a set of physical addresses. For example, processing logic can translate the logical address into the set of physical addresses of a physical address space by using a set of translation functions. The set of physical addresses can correspond to a data item (e.g., byte or word). For example, the set of translation functions can include a position address translation function that translates the logical address to a position address of set of physical addresses. As another example, the set of translation functions can further include a section address translation function that translates the logical address to a section address of the set of physical addresses. The position address can specify a location of the data item (e.g., byte or word) within a datacache section of a set of datacache sections of datacache, and the section address can specify the datacache section. For example, the datacache can correspond to a page buffer area.

More specifically, the position address translation function can translates the logical address to a position address of the set of physical addresses based on a cardinality of a set of datacache sections, and the section address translation function can translate the logical address to a section address of the set of physical addresses based on the cardinality of the set of datacache sections. In some implementations, the position address is represented by CA[k−1:m], where k is a bit value, m=┌log 2 N┐, and N is the cardinality of the set of datacache sections. In some implementations, the section address is representation by CA[m−1:0]. In some implementations, the position address translation function defines the position address as a remainder of a value equal to the logical address divided by the cardinality of the set of datacache sections. In some implementations, the section address translation function defines the section address as a truncation of a value equal to the logical address divided by the cardinality of the set of datacache sections.

At operation 530, a set of media access operations is processed in parallel. For example, processing logic can cause, using the position address and the section address, the set of datacache sections to process the set of media access operations in parallel (e.g., simultaneously or near-simultaneously).

In some implementations, the cardinality of the set of datacache sections is not a power of two. That is, the datacache can be divided into a non-power-of-two number of sections defining the set of datacache sections. In these implementations, translations between logical addresses to respective sets of physical addresses (e.g., the translation performed at operation 520) can be used to effectively remove any discontinuities that may exist in the resulting column address mapping between the physical address space and the logical address space. Accordingly, the translation can enable implementation of a datapath architecture with non-power-of-two parallelism. Further details regarding operations 510-530 are described above with reference to FIGS. 3A-4.

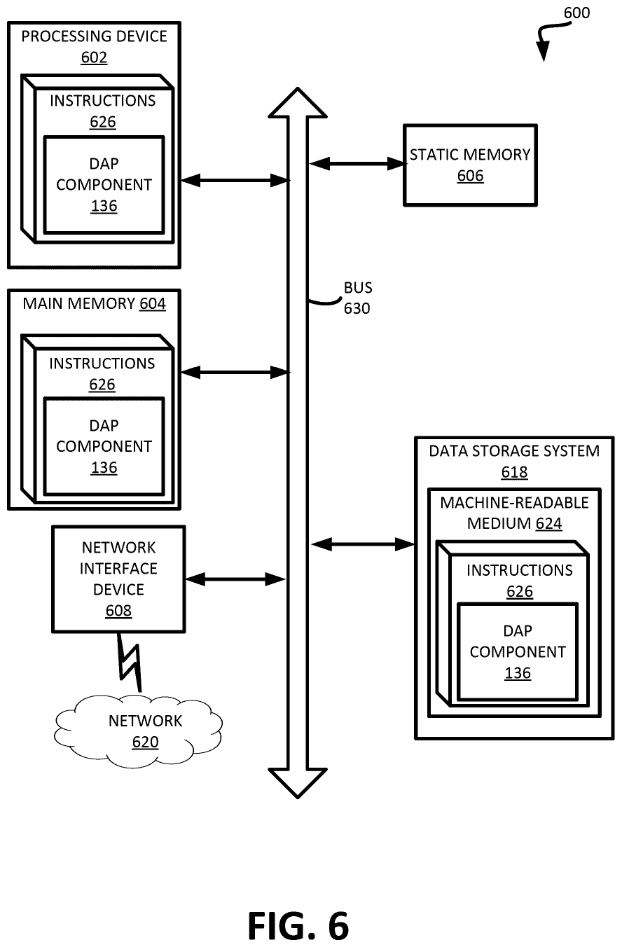

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1A) that includes, is coupled to, or utilizes a memory sub-system (e.g., the memory sub-system 110 of FIG. 1A) or can be used to perform the operations of a controller (e.g., to execute an operating system to perform operations corresponding to the DAP component 137 of FIG. 1A). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM), etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1A.

In one embodiment, the instructions 626 include instructions to implement functionality corresponding to a DAP component (e.g., the DAP component 137 of FIG. 1A). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A memory device comprising:
a memory array; and
processing logic, operatively coupled with the memory array, to perform operations comprising:
identifying a logical address of a logical address space;
translating the logical address to a set of physical addresses of a physical address space by using a set of translation functions, the set of translation functions comprising a position address translation function that translates the logical address to a position address of the set of physical addresses based on a cardinality of a set of datacache sections, and a section address translation function that translates the logical address to a section address of the set of physical addresses based on the cardinality of the set of datacache sections; and
causing, using the position address and the section address, the set of datacache sections to process a set of media access operations in parallel, each media access operation of the set of media access operations corresponding to a respective datacache section of the set of datacache sections.

2. The memory device of claim 1, wherein the position address specifies a location of a data item within a datacache section of the set of datacache sections, and wherein the section address specifies the datacache section.

3. The memory device of claim 1, wherein the position address translation function defines the position address as a remainder of a value equal to the logical address divided by the cardinality of the set of datacache sections.

4. The memory device of claim 1, wherein the section address translation function defines the section address as a truncation of a value equal to the logical address divided by the cardinality of the set of datacache sections.

5. The memory device of claim 1, wherein the position address is represented by CA[k−1:m], wherein k is a bit value, wherein m=┌log 2 N┐, and wherein N is the cardinality of the set of datacache sections.

6. The memory device of claim 1, wherein the section address is represented by CA[m−1:0], wherein m=┌log 2 N┐, and wherein Nis the cardinality of the set of datacache sections.

7. The memory device of claim 1, wherein the cardinality of the set of datacache sections is not equal to a power of two.

8. A method comprising:
identifying, by a processing device, a logical address of a logical address space;
translating, by the processing device, the logical address to a set of physical addresses of a physical address space by using a set of translation functions, the set of translation functions comprising a position address translation function that translates the logical address to a position address of the set of physical addresses based on a cardinality of a set of datacache sections, and a section address translation function that translates the logical address to a section address of the set of physical addresses based on the cardinality of the set of datacache sections; and
causing, by the processing device using the position address and the section address, the set of datacache sections to process a set of media access operations in parallel, each media access operation of the set of media access operations corresponding to a respective datacache section of the set of datacache sections.

9. The method of claim 8, wherein the position address specifies a location of a data item within a datacache section of the set of datacache sections, and wherein the section address specifies the datacache section.

10. The method of claim 8, wherein the position address translation function defines the position address as a remainder of a value equal to the logical address divided by the cardinality of the set of datacache sections.

11. The method of claim 8, wherein the section address translation function defines the section address as a truncation of a value equal to the logical address divided by the cardinality of the set of datacache sections.

12. The method of claim 8, wherein the position address is represented by CA[k−1:m], wherein k is a bit value, wherein m=┌log 2 N┐, and wherein N is the cardinality of the set of datacache sections.

13. The method of claim 8, wherein the section address is represented by CA[m−1:0], wherein m=┌log 2 N┐, and wherein N is the cardinality of the set of datacache sections.

14. The method of claim 8, wherein the cardinality of the set of datacache sections is not equal to a power of two.

15. A non-transitory computer-readable storage medium comprising instructions that, when executed by a processing device, cause the processing device to perform operations comprising:
identifying a logical address of a logical address space;
translating the logical address to a set of physical addresses of a physical address space by using a set of translation functions, the set of translation functions comprising a position address translation function that translates the logical address to a position address of the set of physical addresses based on a cardinality of a set of datacache sections, and a section address translation function that translates the logical address to a section address of the set of physical addresses based on the cardinality of the set of datacache sections; and
causing, using the position address and the section address, the set of datacache sections to process a set of media access operations in parallel, each media access operation of the set of media access operations corresponding to a respective datacache section of the set of datacache sections.

16. The non-transitory computer-readable storage medium of claim 15, wherein the position address specifies a location of a data item within a datacache section of the set of datacache sections, and wherein the section address specifies the datacache section.

17. The non-transitory computer-readable storage medium of claim 15, wherein the position address translation function defines the position address as a remainder of a value equal to the logical address divided by a cardinality of the set of datacache sections.

18. The non-transitory computer-readable storage medium of claim 15, wherein the section address translation function defines the section address as a truncation of a value equal to the logical address divided by a cardinality of the set of datacache sections.

19. The non-transitory computer-readable storage medium of claim 15, wherein the position address is a position address represented by CA[k−1:m], wherein the section address is a section address represented by CA[m−1:0], wherein k is a bit value, wherein m=┌log 2 N┐, and wherein N is the cardinality of the set of datacache sections.

20. The non-transitory computer-readable storage medium of claim 15, wherein the set of datacache sections has a cardinality not equal to a power of two.
